(19) United States
(12) Patent Application Publication
(10) Pub. No.: US 2015/0152840 A1
(43) Pub. Date: Jun. 4, 2015

(54) Dual-Turbine Wind Power Station Placed on a Vertical Axis

(71) Applicants: Istvan Varga, Szekesfehervar (HU); Jeno Csongor Kovacs, Zirc (HU)

(72) Inventors: Istvan Varga, Szekesfehervar (HU); Jeno Csongor Kovacs, Zirc (HU)

(21) Appl. No.: 14/345,404

(22) PCT Filed: Sep. 14, 2012
(86) PCT No.: PCT/HU2012/000091

§ 371 Date: Feb. 19, 2015

(30) Foreign Application Priority Data
Sep. 15, 2011 (RU) P1100512

(51) Int. Cl. F03D 3/02; F03D 11/02; F03D 9/00; F03D 11/00; F03D 3/00; F03D 3/06

(52) U.S. Cl. CPC F03D 3/02; F03D 3/005; F03D 3/061; F03D 9/002; F03D 11/0008; F03D 11/02

(57) ABSTRACT

The invention pertains to a dual-turbine wind power station arranged on a vertical axis, having a machine housing (1) constructed over a solid base, a roof-like structure (2) appropriate to its height, and an internal rotor (3) composed of a series of blades. The wind power station is characterised in that the external rotor (10), which rotates in a direction opposite that of the internal rotor (3) and that is also composed of a series of blades, is arranged on a vertical axis it shares with the internal rotor (3). The lower shaft ends (4, 11) of the internal rotor (3) and external rotor (10) are furnished with lower sets of bearings (5, 12), while the upper shaft ends (6, 13) are furnished with upper sets of bearings (7, 14), all sets of bearings providing for rotation motion about the vertical axis. The lower shaft ends (4, 11) of the two rotors are connected to first and second electric energy-producing electric machines (9, 16), either directly, or with the aid of first and second transmission devices (8, 15). Connected directly to the machine housing (1) is an oval support structure (17) that surrounds the internal rotor (3) and external rotor (10), which holds the rotors very stably by means of lower sets of bearings (5, 12) and upper sets of bearings (7, 14), permitting them to rotate seamlessly.

This invention pertains to a dual turbine wind power station placed on a vertical axis, which both makes use of, and converts wind energy to produce electrical power.

The output of electrical energy produced can be varied over a broad scale, rendering it useful for a wide range of purposes, from household supply to power plant applications. Thus, for instance, it can be used to furnish power to family homes, housing complexes, and industrial plants; to meet auxiliary energy needs; or to operate power plants. In fact, individual wind power stations can be used in concert to create entire wind farms.

Numerous solutions for the production of wind turbines or wind power stations with vertical axes are known:

Among industrial property protection documents, an example of prior art is found in patent specification US 2004141845, pertaining to a wind turbine having two counter-rotating rotors mounted on two vertical axes spaced at a distance apart from each other. Each rotor has a plurality of rotor blades extending generally inward from an outer circumference. The vertical axes are mounted onto a support frame, which is in turn rotatable on a third vertical axis on a platform. With this known solution, while the wind blows onto the drive-side blades, the solution does not feature a brake side; furthermore, it requires a rotational structure to operate, so that the drive-side blades are turned in the direction of the wind. In addition, the rotors are mounted not onto a shared axis, but onto separate vertical axes.

Also representing prior art is the vertical-axis wind turbine described by patent specification US 2009146432, which also has two rotating parts, with rows of curved blades coupled together by gears underneath their shafts so as to rotate synchronously in opposite directions. This solution employs the same principle as patent specification US 2004141845, but in a different form. This known wind turbine, too, employs rotors mounted on two separate axes, while also using a separate drive mechanism for orienting the machine into the wind.

Another example of prior art is patent number U.S. Pat. No. 6,740,989, pertaining to a vertical-axis wind turbine having a turbine rotor with rotor blades disposed for rotation about a substantially vertical axis. The turbine includes multiple vertically extending standing stator vanes spaced circumferentially about the rotor in an annular array. Each vane has a radially inward facing surface, a radially outward facing surface, and a flange on its outer edge. This flange serves to create a turbulent, swirling boundary layer on the surfaces of the vanes that rotates in a direction that draws and redirects air flow into the air flow channels defined by the stator vanes, that is then compressed by the narrowing of the channels and directed to the rotor blades to drive the turbine. This solution uses only one rotor, produces power only on the drive side, and, since it has no brake side, cannot produce a brake-side output.

A solution that stands in closer proximity to this invention is published patent application P0700705, pertaining to a vertical-axis wind turbine and wind power plant. The wind turbine has both a rotor, and a generator connected to the axis of this rotor, along with a supporting structure that holds the axis of the rotor by means of bearings. The rotor consists of an axis fitted with a bearing mounted in the upper part of a support strut and a bearing mounted in the upper part of a building located below the ground level; supporting rings perpendicularly attached to the axis and spaced apart along the axis; and a plurality of arcuate beams with a grid-like structure that are attached to. the rings and that hold curved turbine blades. One embodiment of this invention can be constructed to an arbitrary height, with horizontal floors fashioned along its height at equal distances from each other. Between these floors is a standing rotor consisting of support rings attached to divided axes at specific distances from one another and securing arcuate beams that are attached to the support rings and that hold curved turbine blades, where the axis/axes of the rotor pass through an opening in the floor and are mounted onto bearings in the opening. With this known invention, a standing part and a rotor (rotating part) are used, and the blades located in the standing part channel wind arriving from any direction onto the drive-side blades of the rotor, which then rotate to produce electrical energy with the aid of an electrical machine. The rectangular standing parts attached in fixed fashion to the two edges of the power plant receive relatively heavy wind loads, so that a strong support structure is required. For its own part, this strong support structure can only be made of a relatively large quantity of material, which significantly increases production costs. Another disadvantage is that when constructed to be tall (27 m), the support structure will sway relatively dramatically (up to several meters), which jeopardises safe operation. Because of the use of a standing part, another disadvantage is that output is relatively small, as it is produced only on the drive side.

This invention has as its set objectives the elimination of the deficiencies of known solutions and the creation of a vertical-axis, dual-turbine wind power station that uses wind energy with greater efficiency, functions even when wind strength is low, can be used for a broad range of applications, depending on the power needed, and can be manufactured simply and economically.

The solution according to this invention is founded on the realisation that if the standing part found in known solutions is replaced by a second (what will be termed an “external”) rotor that comprises a series of blades, acts to decrease wind loads, and yet utilises this wind energy, as well, whereby air flowing downward in directed fashion from its blades is channelled onto an internal rotor constructed of a series of blades and arranged on a vertical axis it shares with the external rotor, and that rotates in a direction opposite to that of the external rotor; if the lower and upper ends of the shafts of the internal and external rotors are furnished with lower and upper bearings; if the rotational motion created in this way is converted, directly or indirectly, into electrical energy; and if the internal and external rotors are surrounded by an oval support structure constructed as a grid-like shell that is secured at the top and bottom; then the vertical-axis, dual-turbine wind power station according to this invention meets its set objectives.

Thus, this invention pertains to a dual-turbine wind power station arranged on a vertical axis, having a machine housing constructed on a solid base, a roof-like structure appropriate to its height, and an internal rotor composed of a series of blades. The lower shaft end of the internal rotor where the shaft protrudes into the machine housing is furnished with a lower set of bearings that provides for rotational motion about the vertical axis, while the upper shaft end of the internal rotor is also furnished, at a height appropriate to the height of the power station, with an upper set of bearings that also provides for rotational motion about the vertical axis. The lower shaft end of the internal rotor is connected to the first of two electrical machines that produce electrical energy, either directly, or with the aid of a transmission device. The wind power station according to this invention is characterised in that the external rotor, which is also composed of a series of blades and which rotates in a direction opposite that of the internal rotor, is arranged on a vertical axis it shares with the internal rotor, the lower shaft end of which is connected to the machine housing through a lower set of bearings that provides for rotational motion about the vertical axis. The lower shaft end of the internal rotor is placed into the lower shaft end of the external rotor, while the upper shaft end of the external rotor is furnished at a point corresponding to the height of the wind power station with an upper set of bearings that also provides for rotational motion about the vertical axis. The lower shaft end of the external rotor is connected to the second electrical machine that produces electrical energy, either directly or with the aid of a second transmission device. The wind power station also has both an oval support structure, constructed as a grid-like shell, that surrounds the internal and external rotors and is secured to them via lower and upper sets of bearings, and, mounted onto the upper part of the support structure, a roof-like structure.

In one preferred embodiment of the wind power station according to this invention, the lower shaft end of the external rotor is preferably a hollow shaft, while the upper shaft end is also preferably a hollow shaft, or is a solid shaft.

In a second preferred embodiment of the wind power station according to this invention, the support structure is of lighter-weight construction, and is three-dimensional in form, preferably quasi-spherical or ellipsoidal.

In another preferred embodiment of the wind power station according to this invention, the first and second transmission devices are preferably gear or belt transmissions.

In yet another preferred embodiment of the wind power station according to this invention, the first and second electrical machines are preferably generators.

The solution according to this invention is discussed below by means of the following drawings:

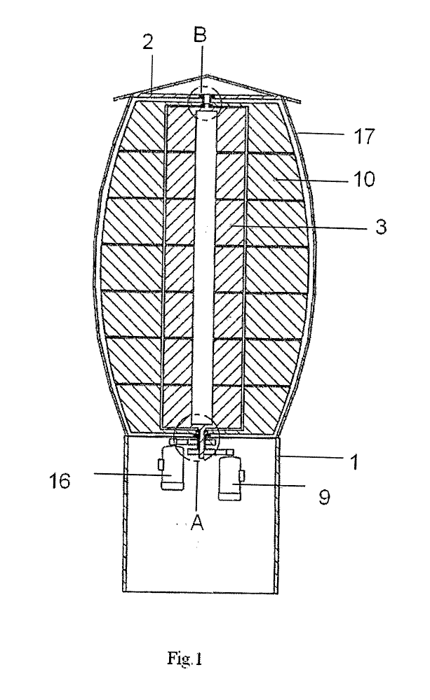

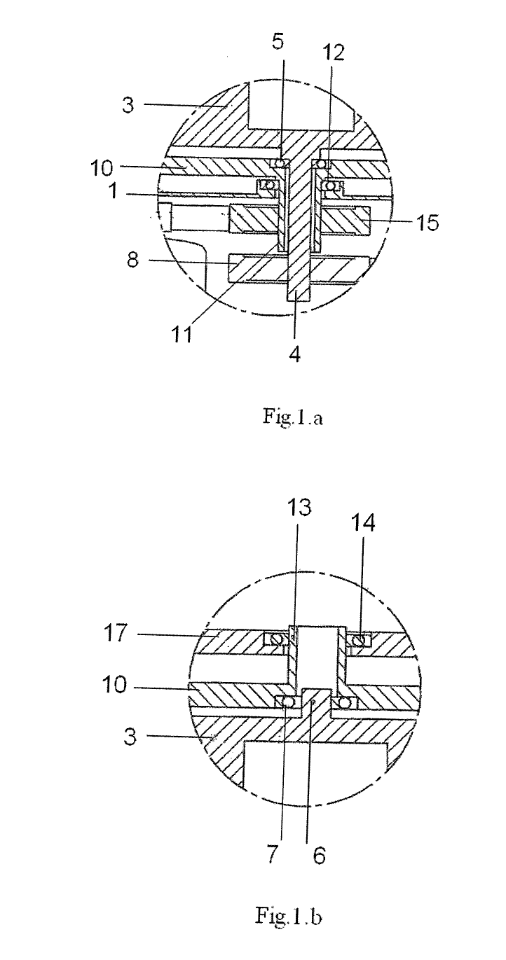

FIG. 1 shows a vertical section of the structure of the wind power station according to this invention,

FIG. 1a shows a magnified drawing of detail A of FIG. 1,

FIG. 1b shows a magnified drawing of detail B of FIG. 1,

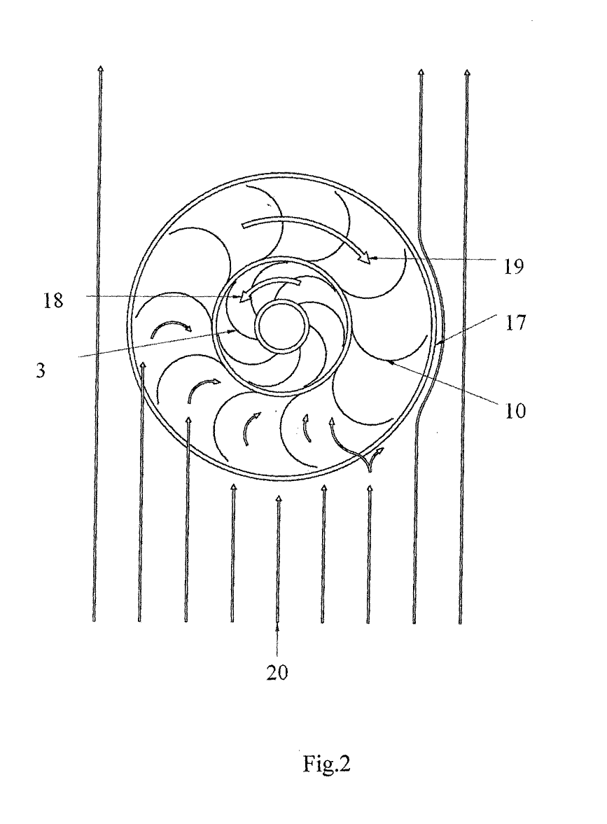

FIG. 2 shows a horizontal section of the conceptual structure of the wind power station according to this invention.

Visible in FIG. 1 is a vertical section of the conceptual structure of the wind power station according to this invention. The wind power station has a machine housing (1) built on a solid base, a roof-like structure (2) appropriate to its height, and an internal rotor (3) constructed of a series of blades. Placed on the machine housing (1) are, among other things, both the first electrical machine (9) and the second electrical machine (16). The wind power station has an external rotor (10) that is also composed of a series of blades, which rotates on a vertical axis it shares with the internal rotor (3). The internal rotor (3) and external rotor (10) are surrounded by an oval support structure (17) in the form of a grid-like shell, that is connected directly to the machine housing (1) and is secured by the lower and upper sets of bearings depicted in detail drawings A and B and shown in greater detail in FIGS. 1a and 1b. Mounted onto the upper part of the support structure (17), in turn, is a roof-like structure (2).

FIG. 1a shows essentially a magnification of Detail A of FIG. 1 with the lower set of bearings about the internal rotor (3) and external rotor (10), the first transmission device (8), and the second transmission device (15). The internal rotor (3) has a lower shaft end (4), furnished with a lower set of bearings (5) that provides for rotational motion about the vertical axis at the point where it extends into the machine housing (1). The external rotor (10), too, has a lower shaft end (11), which connects to the machine housing (1) through a lower set of bearings (12) that also provides for rotational motion about the vertical axis. The lower shaft end (4) of the internal rotor (3) is placed into the lower shaft end (11) of the external rotor (10). The lower shaft end (4) of the internal rotor (3) connects to the first transmission device (8), while the lower shaft end (11) of the external rotor (10) connects to the second transmission device (15).

In FIG. 1b, a magnification of Detail B of FIG. 1 is visible, with what amounts to the upper sets of bearings of the internal rotor (3) and external rotor (10), along with the support structure (17). The internal rotor (3) has an upper shaft end (6) at a height equal to that of the wind power station, furnished with an upper set of bearings (7) that also provides for rotational motion about the vertical axis. The external rotor (10) has an upper shaft end (13), which is furnished, at the point corresponding to the height of the wind power station, with an upper set of bearings (14) that also provides for rotational motion about the vertical axis. Also visible on the drawing is the support structure (17) that surrounds the internal rotor (3) and external rotor (10), is secured to them by means of two lower sets of bearings (5, 12) and two upper sets of bearings (7, 14), and connects directly to the machine housing (1), as well.

FIG. 2 shows a horizontal section of the conceptual structure of the wind power station according to this invention. Visible in the drawing are the internal rotor (3), the direction of rotation of which (18) is counter-clockwise, and the external rotor (10), the direction of rotation of which (19) is clockwise. Also depicted are the support structure (17) surrounding the internal rotor (3) and external rotor (10) and the wind direction (20) that acts on the external rotor (10).

The wind power station according to this invention operates in the following manner, with reference to the foregoing:

Wind arriving from any wind direction (20) is channelled onto the series of blades belonging to the external rotor (10), at the action of which, with the aid of the lower shaft end (11) and upper shaft end (13) and lower set of bearings (12) and upper set of bearings (14), rotational motion about the vertical axis in a clockwise direction of rotation (19) is created. This rotational motion is channelled to the second electrical machine (16), either directly, or with the aid of the second transmission device (15), thus producing electrical energy. Since the speed of the external rotor (10), at the action of this load, will be less than the speed of the wind, the air flowing from the channelling blades of the external rotor (10) reaches nearly three-fourths of what are termed the drive-branch blades of the internal rotor (3), at the action of which again, with the aid of the lower shaft end (4) and the upper shaft end (6) and the lower set of bearings (5) and the upper set of bearings (7), rotational motion about the vertical axis is created, the direction of rotation (18) of which is opposite the direction of rotation (19) of the external rotor (10). The rotational motion created in this way is then channelled to the first electrical machine (9), either directly, or with the aid of the first transmission device (8), again producing electrical energy. In this way, electrical energy is created with two separate electrical machines, made possible by the use of two rotors arranged on a shared vertical axis, and an oval support structure (17) in the form of a grid-like shell surrounding the internal rotor (3) and external rotor (10). Since the blades between the grid members of the support structure (17) can be turned regardless of wind direction, the support structure (17) endures, in practice, a lighter load. In the event there is a need for more electrical energy, then two or more wind power stations according to this invention—as independent units—can be built on top of each other. In this case, for example, when two wind power stations are connected, an “intermediate” set of bearings may be used in addition to the lower and upper sets of bearings.

In one preferred embodiment of the wind power station according to this invention, the machine housing (1) is built on a solid base, preferably of concrete. Placed in the machine housing (1) are the lower shaft end (4) of the internal rotor (3) with a lower set of bearings (5) located along the lower portion of it providing rotational motion, the first transmission device (8) connected to the lower shaft end (4), and the first electrical machine (9). Also placed in the machine housing (1) is the lower shaft end (11) of the external rotor (10), which also connects to the machine housing (1) through a lower set of bearings (12) providing rotational motion. The lower shaft end (11) of the external rotor (10) is placed into the lower shaft end (4) of the internal rotor (3). Also installed in the machine housing (1) are the second transmission device (15), connected to the lower shaft end (11), and the second electrical machine (16). The internal rotor (3) has an upper shaft end (6) at a height equal to that of the wind power station, furnished with an upper set of bearings (7) that provide for rotation motion. The external rotor (10) also has an upper shaft end (13) at a height equal to that of the wind power station, furnished with an upper set of bearings (14) that provide for rotational motion. Both the internal rotor (3) and the external rotor (10) are constructed of series of blades. These blades are formed so that the wind power station is operable even when the wind strength is small, and when the wind strength is great, their braking blade form prevents the wind from being caught by and thus pushing the external rotor (3). The number of blades is determined based on wind speed; when the wind speed is lower, a greater number of channelling blades must be used. In reality, with the solution according to this invention, air flowing in a directed manner from the channelling blades of the external rotor (10) is channelled from the braking side to the series of blades on the internal rotor (3) on the drive side, which rotates in a direction opposite that of the external rotor (10). Thus, the rotational motions created by the external rotor (10) and the internal rotor (3) can be converted into electrical energy using the first and second electrical machines (9, 16), which raises efficiency as compared to other known solutions. Attached directly to the machine housing (1) is the lower part of the oval support structure (17), whose form is of a grid-like shell. The support structure (17) surrounds the internal rotor (3) and the external rotor (10), and thus protects the blades. The support structure (17) is secured to the internal rotor (3) and the external rotor (10) by means of the lower sets of bearings (5, 12) and upper sets of bearings (7, 14); the external rotor (10) is secured to the support structure (17), and the internal rotor (3) is secured to the external rotor (10).

The support structure (17), secured in this way, holds the external rotor (10) and the internal rotor (3) rigidly and very stably, and also ensures that their rotational motion is seamless. The grid-like shell shape enables the blades between the grid members of the support structure (17) to be rotated irrespective of wind direction. In one preferred embodiment of this invention, the support is of lighter-weight construction, and is three-dimensional in form, preferably quasi-spherical or ellipsoidal, as this prevents swaying and increases stability.

The roof-like structure (2) is placed onto the upper part of the support structure (17), thus topping the wind power station at the highest point of its construction.

According to another preferred embodiment of this invention, the lower shaft end (11) of the external rotor (10) is preferably hollow, while its upper shaft end (13) is also preferably hollow, or is solid.

In a further preferred embodiment of this invention, the first and second transmission devices (8, 15) are gear or belt transmissions.

In yet another preferred embodiment of this invention, the first and second electrical machines (9, 16) are preferably generators.

The solution according to this invention meets its set objectives, thus offering the following advantages:
It has no standing part, but only two rotors arranged on a vertical axis, of which not only the internal rotor, but also the external rotor produces electrical energy, thus increasing efficiency;
The oval support structure, in the form of a three-dimensional, grid-like shell, is of a lighter-weight construction, increasing stability, preventing swaying, and, since the blades that fill the space between the grid members of the support structure can be rotated irrespective of wind direction, reducing static loading; it also protects the blades;
The blades that fill the space between grid members increase efficiency and promote wind capture;
It will function even when wind strength is low;
When the wind is strong, there is no appreciable braking effect, since the air flows over the external rotor;
It can be produced simply;
It occupies little space;
Multiple units can be installed close together;
It is more economical than other, known solutions, 1 kW of electrical energy costing around 60 to 70% of the usual energy price to produce.
Depending on the output required, the invention makes possible use on a broad scale, from household supply to meeting the needs of power plants, examples including the supply of power to family homes, housing complexes, and industrial facilities, meeting auxiliary energy needs, or even creating entire wind farms.

### LIST OF REFERENCE NUMBERS

1 machine housing
2 roof-like structure
3 internal rotor
4 lower shaft end
5 lower set of bearings
6 upper shaft end
7 upper set of bearings
8 first transmission device
9 first electric machine
10 external rotor
11 lower shaft end
12 lower set of bearings
13 upper shaft end
14 upper set of bearings
15 second transmission device
16 second electric machine
17 support structure
18 direction of rotation
19 direction of rotation
20 wind direction

1. A dual-turbine wind power station arranged on a vertical axis, comprising:
a machine housing constructed over a solid base,
an internal rotor comprising one or more blades,
an internal shaft having a lower set of bearings at a point on its lower end and an upper set of bearings at a point on its upper end both of which provide for rotational motion of the shaft about the vertical axis of the internal shaft the lower end of which is connected to a first electric energy-producing electrical machine either directly, or with the aid of a first transmission device
an external rotor which rotates in a direction opposite to that of the internal rotor comprising one or more blades, an external shaft which rotates about the vertical axis it shares with the internal rotor, the external shaft having a lower set of bearings at a point on its lower end and an upper set of bearings at a point on its upper end both of which provide for rotational motion of the shaft about the vertical axis of the external shaft wherein the lower shaft end of the internal rotor is placed into the lower shaft end of the external rotor and the lower end of the external shaft is connected to a second electric energy-producing electrical machine either directly, or via a second transmission device and,
an oval support structure comprising a grid-like shell that surrounds the internal rotor and external rotor.

2. The wind power station according to claim 1, wherein the lower shaft end of the external rotor is hollow.

3. The wind power station according to claim 1, wherein the oval support structure has a three-dimensional shape that is spherical, quasi-spherical or ellipsoidal.

4. The wind power station according to claim 1 wherein the first and second transmission devices are gear or belt transmissions.

5. The wind power station according to claim 1 wherein the first and second electrical machines are generators.
